(19) United States
(12) Patent Application Publication
(10) Pub. No.: US 2002/0190518 A1
(43) Pub. Date: Dec. 19, 2002

(54) Anchor with an improved fixing structure and method for manufacturing the same

(76) Inventor: Jin Hee Kang, Seoul (KR)

Correspondence Address: G W i P S, Global Wide international Patent Service, Kang Nam, P.O. Box 2301, Seoul, 135-621, KR

(21) Appl. No.: 10/028,683

(22) Filed: Dec. 28, 2001

(30) Foreign Application Priority Data
Jun. 15, 2001 (KR) 10-2001-33764
Jun. 15, 2001 (KR) 10-2001-33766
Sep. 27, 2001 (KR) 10-2001-59947
Nov. 26, 2001 (KR) 10-2001-73941
Nov. 26, 2001 (KR) 10-2001-73942

(51) Int. Cl. B60R 22/00

(52) U.S. Cl. 280/801.1

(57) ABSTRACT

An anchor with an improved fixing structure comprises a lower part (1a) having a slot (2) for suspending the seatbelt and an upper part (1b) having a fastener tubes for stably installing the anchor on a vehicle body panel. The fastener tube has various shapes with a predetermined height and diameter for providing a proper clearance between the anchor and vehicle body panel. The fastener tube is also integrally and vertically formed from with the upper part of anchor. The anchor with the improved fixing structure is designed not only to eliminate a bushing being used in the conventional anchor assembly, but also to provide stable installation of the anchor on the vehicle body panel. Therefore, the overall assembly cost is remarkably reduced. Additionally, the assembly workers are free form the worry of accidental omitting a bushing during the seatbelt assembly.

### BACKGROUND OF THE INVENTION

1. Field of the Invention

The present invention relates to an anchor with an improved fixture for installing a seatbelt device. More particularly, it concerns the various shapes of fixing structure of anchor for stably installing an anchor on a vehicle body panel.

2. Description of the Related Art

Generally, a seatbelt is rolled up when it is not in use, and it is unrolled from the rolled-up state when the user pulls the seatbelt to wear it.

FIG. 1 illustrates a typical seatbelt being mounted on an automobile seat. One end of connection belt (20) is mounted on one side of passenger seat (D) by an anchor (70). A buckle (10) is attached at the other end of connection belt (20). A retractor (30) is fixed at the lower part of passenger seat (D) or vehicle body (B). A pillar anchor (60) is fixed at the upper part of vehicle body (B) locating just above passenger's shoulder for suspending the seatbelt. The seatbelt (40) is rolled up and stored inside the retractor (30) as a reservoir. A coupler (50) is attached at the end of seatbelt (40) for coupling or uncoupling the buckle (10) depending on the passenger's intention. The seatbelt (40) is suspended through the pillar anchor (60) for easily operating by a passenger. At an end of auxiliary seatbelt, a secondary anchor (80) is mounted on the vehicle body (B) or passenger seat (D) at the opposite side from the first anchor (70).

FIGS. 2 and 3 disclose a conventional anchor being used for a seatbelt. The conventional anchor being made of a steel plate (S) comprises a lower part (1a) and upper part (1b). A slot (2) is provided at the mid of lower part (1a) for suspending a seatbelt. A fastener hole (5) is formed at the center of upper part (1b). The belts (20, 40) are installed through the slot (2). A fastener (6) is installed through the fastener hole (5) of anchor. The anchor is mounted on the vehicle body (B) by means of fastener (6) and busing (7).

FIGS. 4 and 5 disclose a conventional pillar anchor as another example. Except the lower part, the conventional pillar anchor has a similar structure to that of conventional anchor as shown in FIGS. 2 and 3, respectively. This type anchor also applies the means of fastener (6) and busing (7) when the pillar anchor is mounted on the vehicle body (B).

A specially designed fastener (6) consists of a disk shaped stopper (6a), an insertion part (6b) and a thread part (6c). The disk shaped stopper (6a) is formed for preventing a fastener head slip out through the fastener hole (5). The insertion part of fastener (6b) is formed with a predetermined height and diameter, which is slightly larger than the thread part (6c) but smaller than the disk shaped stopper (6a) to prevent the fastener moving radial direction in the fastener hole (5).

A nut hole (91) is drilled on a vehicle body panel (90) at a position where an anchor is installed. Then, a nut (92) is welded underneath the nut hole (91). When the anchor is installed on the vehicle body panel, the thread part (6c) of fastener goes through the fastener hole (5) of upper part and nut hole (91) to fasten the anchor with the nut (92) on the vehicle body panel (90).

The seat belt (20, 40) must be apart a certain distance from the vehicle body panel (90) for preventing damages by contact with the vehicle body panel during the operation of the safety seatbelt device. In order to apart a certain distance from the vehicle body panel (90), the upper part (1b) of anchor must be installed with a predetermined clearance from the vehicle body (90). Therefore, the conventional anchor has adapted a cylindrical shape of bushing (7) having a predetermined height and diameter. The inner diameter of busing is slightly larger than outer diameter of thread part (6c) and smaller than outer diameter of insertion part (6b) for disposing between the upper part of anchor and the vehicle body panel (90). Then, the fastener (6) is inserted through the bushing for mounting the anchor on the vehicle body (90). At this time, the disk shaped stopper (6a) is located slightly above the fastener hole (5) of upper part (1b). The insertion part (6b) of fastener (6) is smoothly contacted inside surface of fastener hole (5).

During the assembly, the bushing (7) is installed one or more to adjust the clearance depending on vehicles types. Accordingly, the overall length of fasteners (6) varies depending on the installed numbers of bushings. When the installed number of bushings between the conventional anchor and vehicle body is increased, the mounting fastener must be lengthened. Thus, the manufacturing cost of safety belt is increased.

Even worse, many assembly workers frequently forget to install the bushings (7) to provide a proper clearance during the assembly. Therefore, the seatbelt will be easily jammed during the operation. Thus, it could be a cause of malfunction of seatbelt operation and a potential danger.

### SUMMARY OF THE INVENTION

The present invention has improved by considering and solving the problems of conventional anchors.

The object of the present invention is to provide an anchor for providing a proper clearance between an upper part of the anchor and a vehicle body without adapting a bushing.

Another object of the present invention is to provide an anchor for providing a stable installation on the vehicle body panel.

To achieve the above objects, an anchor with an improved fixing structure has been developed. The anchor being made of a steel plate comprises a lower part (1a) having a slot for suspending a seatbelt and an upper part (1b) having improved fixing structure for stably installing the anchor on the vehicle body panel. A fastener (6) comprising a disk shaped stopper (6a), an insertion part (6b) and a thread part (6c) is used for mounting the anchor on a vehicle body panel (90). At the center of the upper part (1b) of anchor, a cylindrical basin is formed with a predetermined depth. The inside diameter of cylindrical basin (103) is slightly larger than the disk shaped stopper (6a). The lower part of cylindrical basin (103) is formed a flat bottom surface (104). At the center of the flat bottom surface (104), a fastener-hole (105) is formed having slightly larger diameter than the insertion part (6b) and smaller than the disk shaped stopper (6a) of the fastener.

According to the present invention, a process for manufacturing the anchor with the improved fixing structure is as follows:

To form a cylindrical basin shape, the manufacturing process comprises a first step of stamping process to form an initial conical shape (S3a) having a predetermined depth; a second step of pressing process is to round up a tip of initial conical shape (S3a) for forming a transition conical shape (S3b). A basin (S4a) of transition conical shape (S3b) has less depth than that of previous step; a third step of expanding process is to form a transition semi-spherical shape (S3c) by expanding radial direction. A basin (S4b) of transition semi-spherical shape (S3c) has less depth than that of previous step; a fourth step of pressing process is to form a cylindrical basin (S3d) having a final depth with flat bottom (S4c); and final step of punching process is to form a fastener hole (5) at the bottom center of cylindrical basin (S4c).

The various fixing structures could be obtained through the expanding and trimming process for processing the end part of fastener tube. At first step, a basic hole (S21) is punched out on a steel plate (s) for forming an opening of fastener hole (205). At second step, a lower edge of inside basic hole (S21) is rounded up, and at third step an upper edge of inside basic hole (S21) is subsequently rounded up. At forth step, the basic hole (S21) is downwardly expanded to form a secondary basic hole (S22) by gradually increasing a punch size (K28). At the same time, the initial diameter of basic hole (S21) is enlarged to that of secondary basic hole (S22) by inserting and pressing the punch (K28) against die (K27) to form a prototype fastener tube (S24). At fifth step, the secondary basic hole (S22) is further downwardly expanded to form a fastener tube (203) by gradually increasing a punch size (K30). Simultaneously, the diameter of secondary basic hole (S22) is further enlarged to that of fastener tube (203) by inserting and pressing the punch (K30) against die (K29) for forming a proper fastener tube (S24). At sixth step, an edge of fastener tube (203) is rounded up by a punch (K31) and punch (K32). At seventh step, the edge of fastener tube (203) is trimmed to form a flat end. Through the above process, the second embodiment of the present invention is accomplished.

At eighth step, the end part of fastener tube (403) is expanded and pressed up to form a bell shape having larger diameter than that of upper part of fastener tube (403) by an interior end expander (K35).

Alternatively, the end part of fastener tube (503) is expanded and pressed up to form a skirt shaped fastener tube (503) having diameter gradually increased from the upper part (505) to the end of fastener tube by an interior end expander (K35′).

Then, the end part of fastener tube (403) is further expanded and pressed up to form a flange (304) by a stepped interior expander (K35″) and semi-circular side die (K37).

### BRIEF DESCRIPTION OF THE DRAWINGS

FIG. 1 illustrates a schematic drawing of a seatbelt being installed on a passenger seat of a public transportation vehicle.

FIG. 2 is an exploded perspective view of a conventional anchor adopted a bushing and fastener.

FIG. 3 is a sectional view of the conventional anchor installed on a vehicle body panel by adapting a fastener and bushing.

FIG. 4 is another example illustrating an exploded perspective view of conventional pillar anchor adopted a bushing and fastener.

FIG. 5 is another example illustrating a sectional view of conventional pillar anchor adopted a bushing and fastener.

FIG. 6 is an exploded perspective view of anchor with an improved fixing structure of the present invention.

FIG. 7 is a sectional view of first embodiment of anchor with an improved fixing structure of the present invention.

FIG. 8 is a sectional view of second embodiment of anchor with an improved fixing structure of the present invention.

FIG. 9 is a sectional view of third embodiment of anchor with an improved fixing structure of the present invention.

FIG. 10 is a sectional view of forth embodiment of anchor with an improved fixing structure of the present invention.

FIG. 11 is a sectional view of fifth embodiment of anchor with an improved fixing structure of the present invention.

FIG. 12 is an exploded perspective drawing of pillar anchor with an improved fixing structure of the present invention.

FIG. 13 is a sectional view of first embodiment of pillar anchor with an improved fixing structure of the present invention.

FIG. 14 is a sectional view of second embodiment of pillar anchor with an improved fixing structure of the present invention.

FIG. 15 is a sectional view of third embodiment of pillar anchor with an improved fixing structure of the present invention.

FIG. 16 is a sectional view of fourth embodiment of pillar anchor with an improved fixing structure of the present invention.

FIG. 17 is a sectional view of fifth embodiment of pillar anchor with an improved fixing structure of the present invention.

FIGS. 18(a) to (e) illustrate a process for manufacturing a first embodiment of anchor with an improved fixing structure of the present invention.

FIGS. 19(a) to (e) illustrate an alternative process for manufacturing a first embodiment of anchor with an improved fixing structure of the present invention.

FIGS. 20(a) to (e) illustrate another alternative process for manufacturing a first embodiment of anchor with an improved fixing structure of the present invention.

FIGS. 21(a) to (e) illustrate other alternative process for manufacturing a first embodiment of anchor with an improved fixing structure of the present invention.

FIGS. 22(a) to (g) illustrate the common process for manufacturing the second to fifth embodiments of anchor with an improved fixing structure of the present invention.

FIGS. 23(h), (h)′ and (i) illustrate the edge trimming process for forming the various shapes of fastener tube ends.

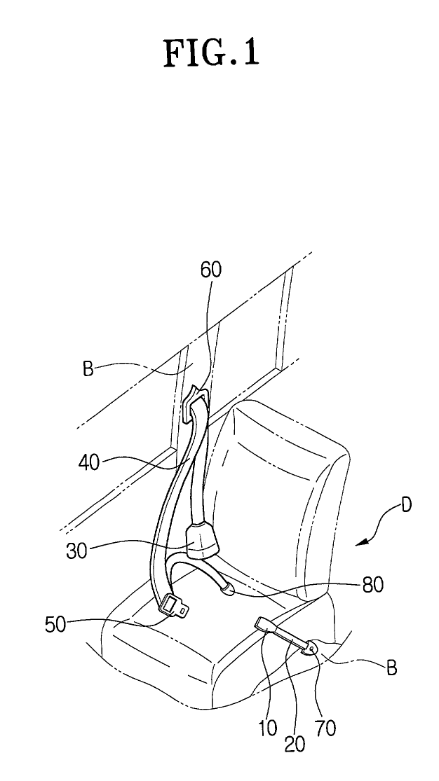

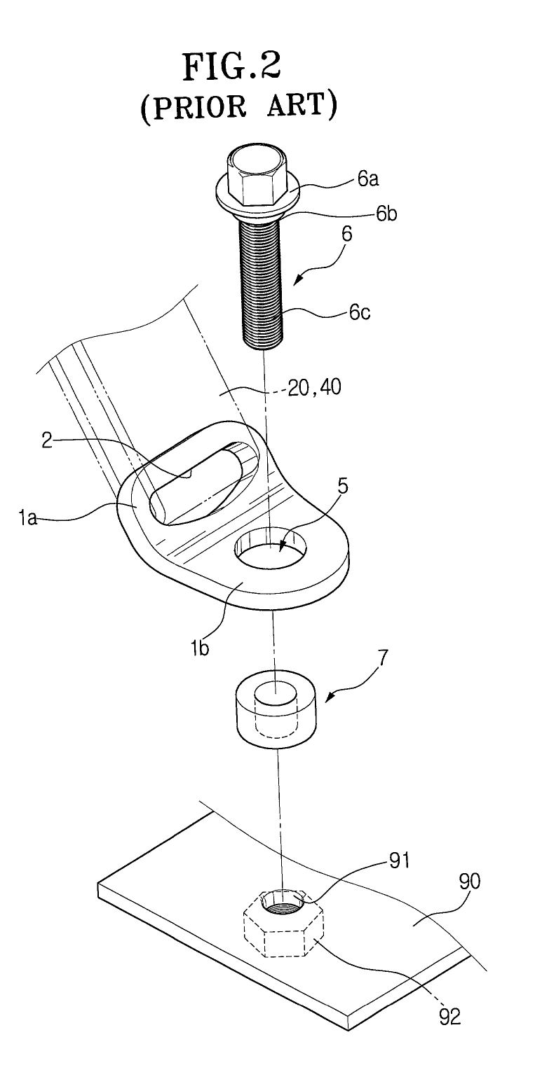

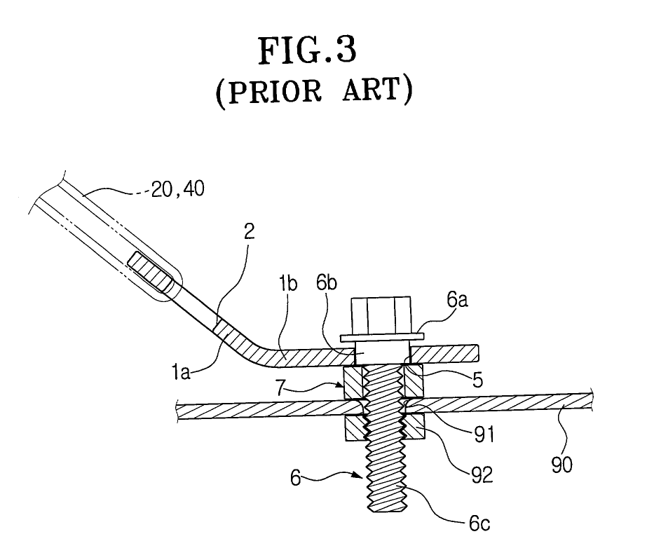

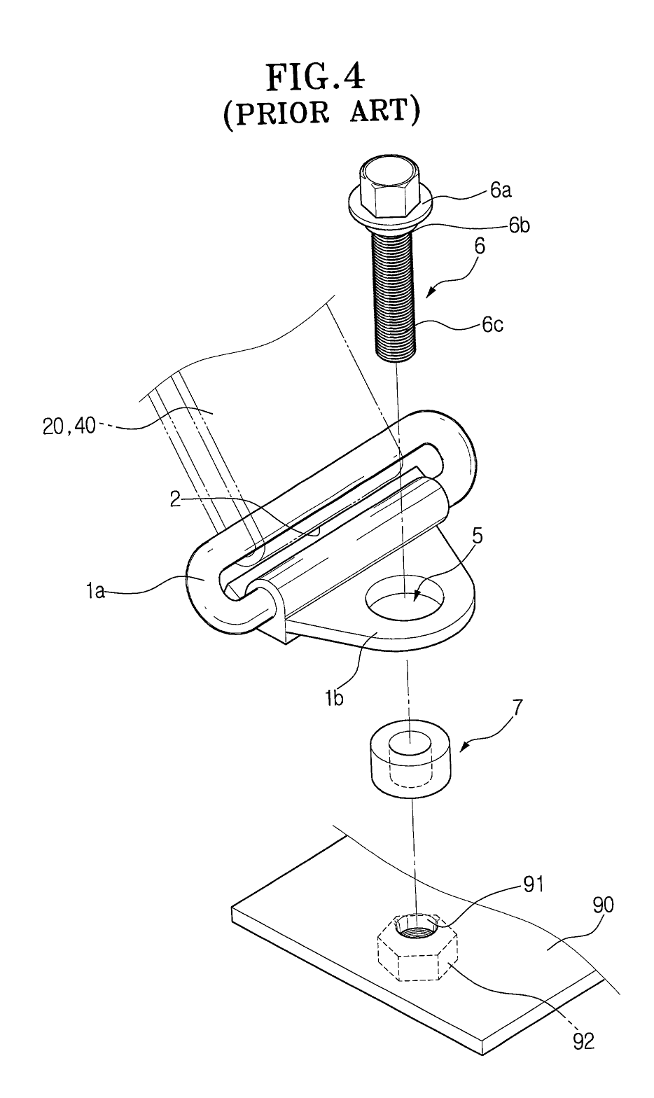

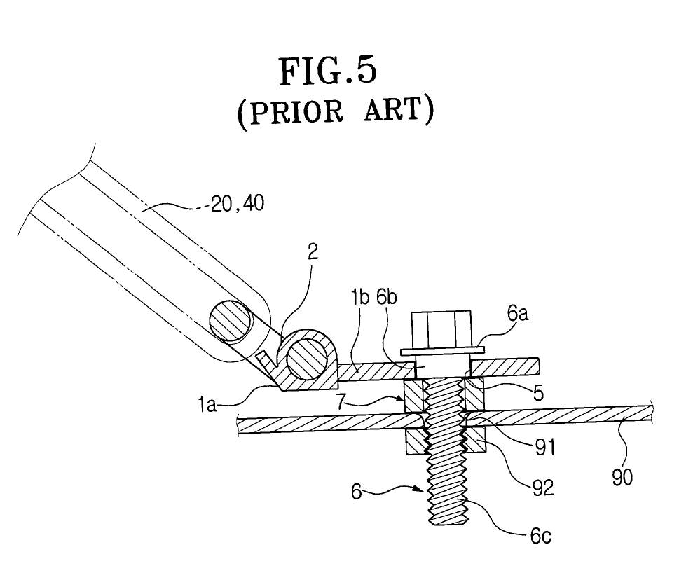

### DETAILED DESCRIPTION OF THE PREFERRED EMBODIMENTS

An anchor with an improved fixing structure and a manufacturing process of the anchor of the present invention are described in detail accompanying with the drawings.

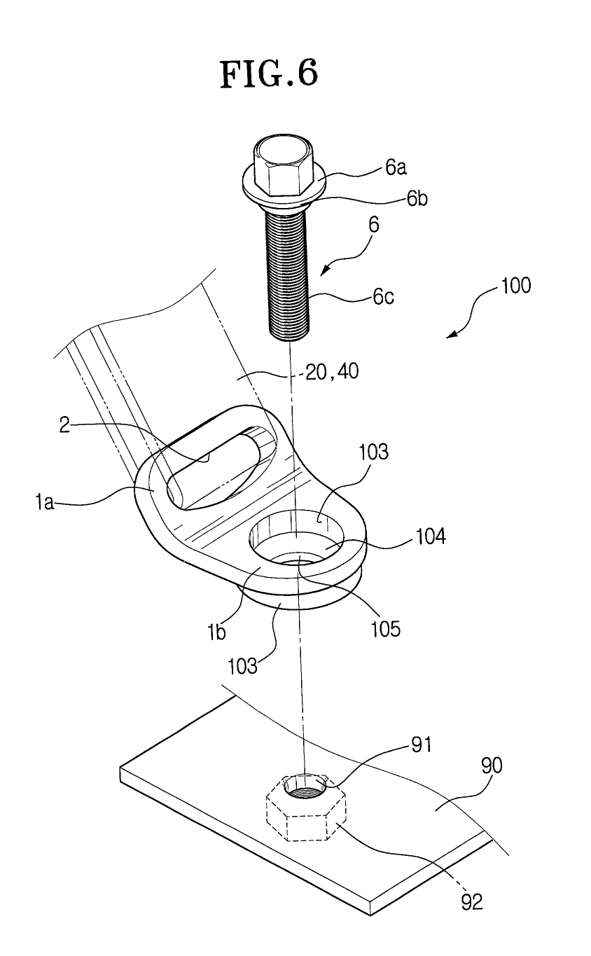

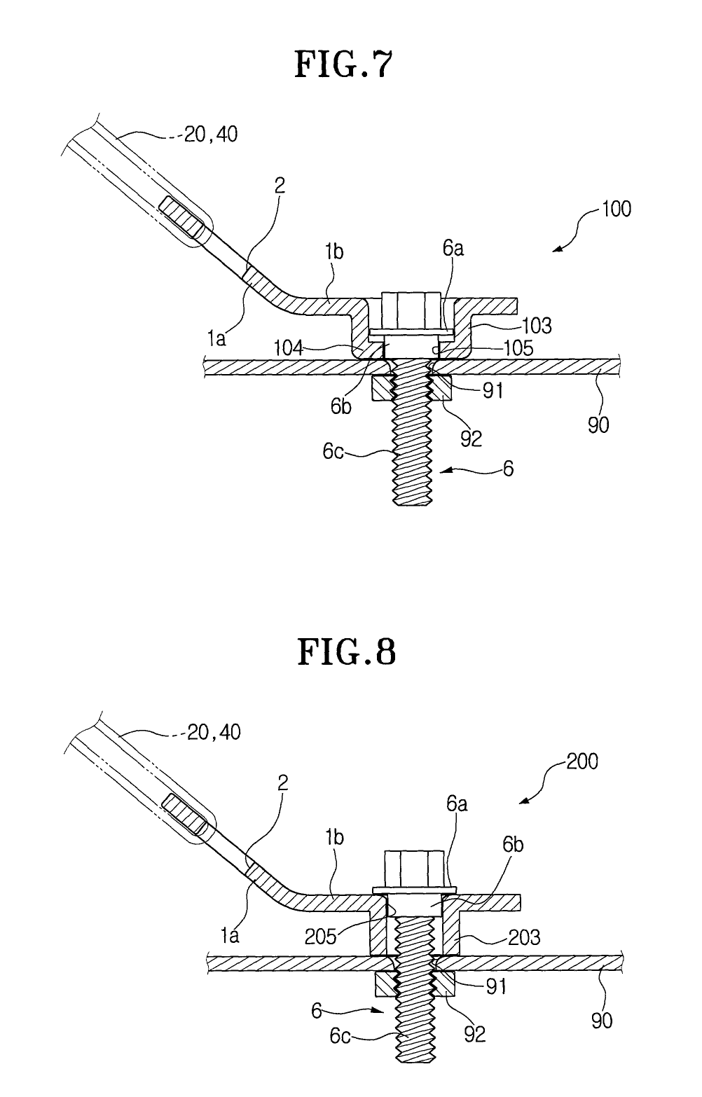

As shown in FIGS. 6 and 7, an anchor with an improved fixing structure illustrates as an example of first embodiment of the present invention. The anchor being made of a steel plate (100) comprises a lower part (1a) having a slot for suspending a seatbelt and an upper part (1b) having a cylindrical basin shape (103) with a predetermined depth at the center of the bottom surface. A diameter of cylindrical basin shape is slightly larger than the disk shaped stopper (6a) of fastener (6). A flat surface (104) is formed at the bottom of cylindrical basin. At a center of the flat surface (104), a fastener hole (105) having slightly larger diameter than an insertion part (6b) and smaller than the diameter of disk shaped stopper (6a) is formed.

The anchor is mounted on a vehicle body panel (90) by inserting the fastener (6) through the fastener hole (105). As shown in FIG. 7, the bolt head (6) and disk shaped stopper (6a) are disposed inside of the cylindrical basin (103) and seated slightly above the bottom surface (104). According to the first embodiment of the anchor (100), the upper part (1b) is apart from the vehicle body panel (90) by the height of cylindrical basin (103).

Therefore, the anchor of the present invention is not required to install a bushing as needed in the conventional anchor. Because the bolt head (6) and disk shaped stopper (6a) are located inside of the cylindrical basin (103), the anchor of the present invention enables to eliminate bushings and to shorten the fastener length. Thus, it also has advantages to reduce the manufacture cost and free from the worry of omitting the bushings during the assembly.

Referring to FIG. 8, a second embodiment of an anchor (200) is illustrated as an example of the improved fixing structure. The second embodiment of the anchor being made of steel plate comprises a lower part (1a) having a slot (2) at a center for suspending a seatbelt and an upper part (1b) having a fastener-tube (203). A diameter of fastener tube is slightly larger than that of an insertion part (6b) and smaller than that of a disk shape stopper (6a). An upper part (205) of fastener-tube (203) is smoothly contacted with the insertion part (6b) of fastener (6). This upper part (205) of fastener tube (203) has a consistent cross section all along the tube height.

As shown in FIG. 8, the anchor is installed on a vehicle body panel (90) by the fastener (6) while the disk shaped stopper (6a) of fastener (6) is seated above the upper part (1b). Therefore, the upper part (1b) of second embodiment of anchor (200) is located apart from the vehicle body panel (90) by the height of fastener-tube (203). Consequently, the anchor of the present invention is not required to install a bushing as needed in the conventional anchor.

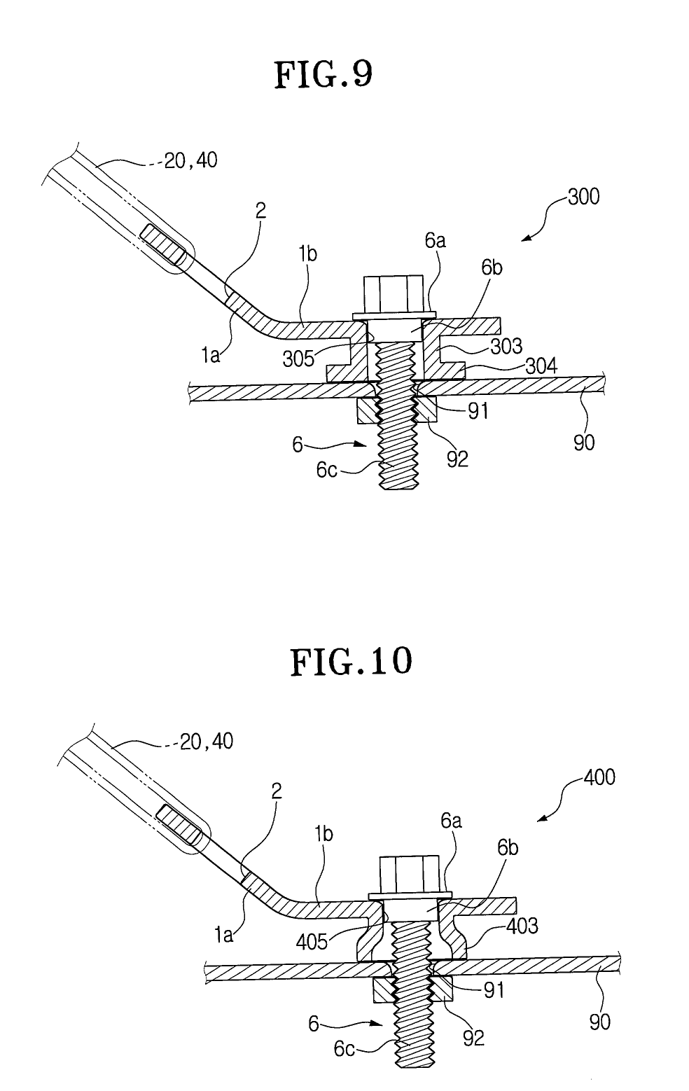

Referring to FIG. 9, a third embodiment of the anchor (300) of the present invention has a flange (304) at the end part of fastener tube (303) in order to stably seat on a vehicle body panel. Comparing this embodiment with previous embodiment, they are identical each other except a radially extended flange being additionally attached at the end of fastener tube (303). A diameter of fastener tube (303) is slightly larger than that of insertion part (6b) and smaller than that of disk shaped stopper (6a). The fastener tube (303) also has a predetermined length for providing a clearance between the upper part (1b) of the anchor and vehicle body panel.

Referring to FIG. 10, it illustrates forth embodiment of the anchor (400). The anchor (400) has an expended end (403) at a lower part of fastener tube in order to stably seat on a vehicle body panel. A diameter of upper part (405) of the fastener tube is slightly larger than that of insertion part (6b) and smaller than that of disk shaped stopper (6a). The diameter of expended end (403) of fastener tube is wider than that of upper part (405) of fastener tube. The fastener tube also has a predetermined height for providing a clearance between the upper part (1b) and vehicle body panel.

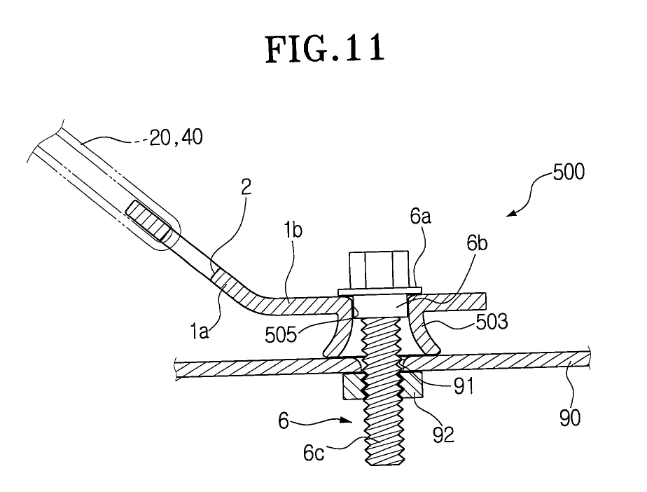

Referring to FIG. 11, it illustrates fifth embodiment of the anchor (500) of the present invention. The anchor (500) has a skirt shaped (503) fastener tube in order to stably seat on a vehicle body panel. A diameter of upper part (505) of fastener tube is slightly larger than that of insertion part (6b) and smaller than that of disk shaped stopper (6a). The diameter of skirt shaped fastener tube (503) is gradually increased from the upper part (505) to the end part of fastener tube. The skirt shaped fastener tube also has a predetermined length for providing a proper clearance between the upper part (1b) and vehicle body panel.

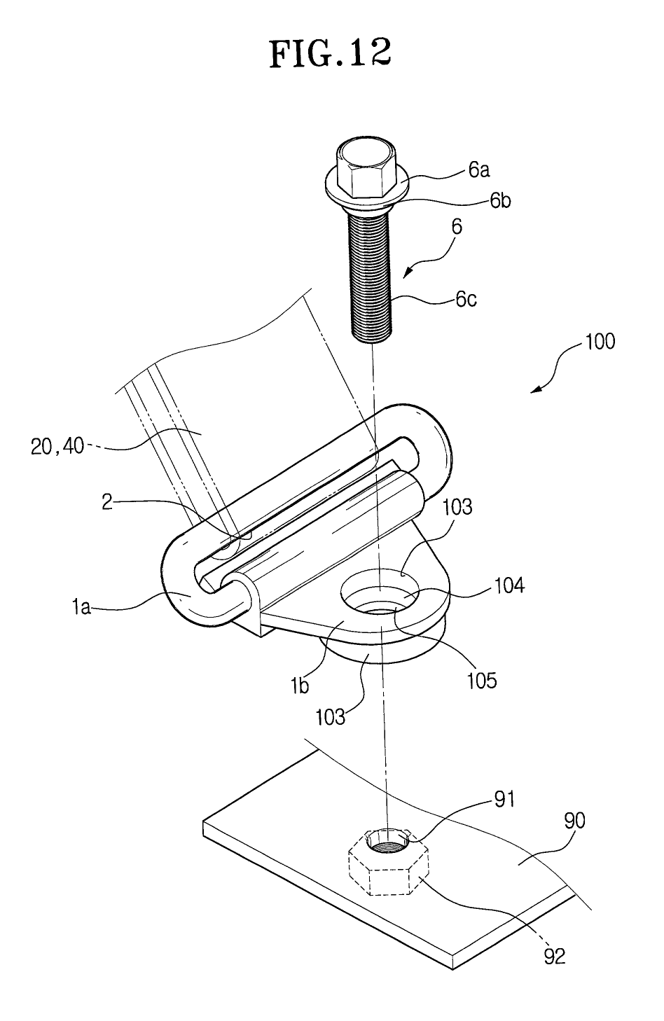

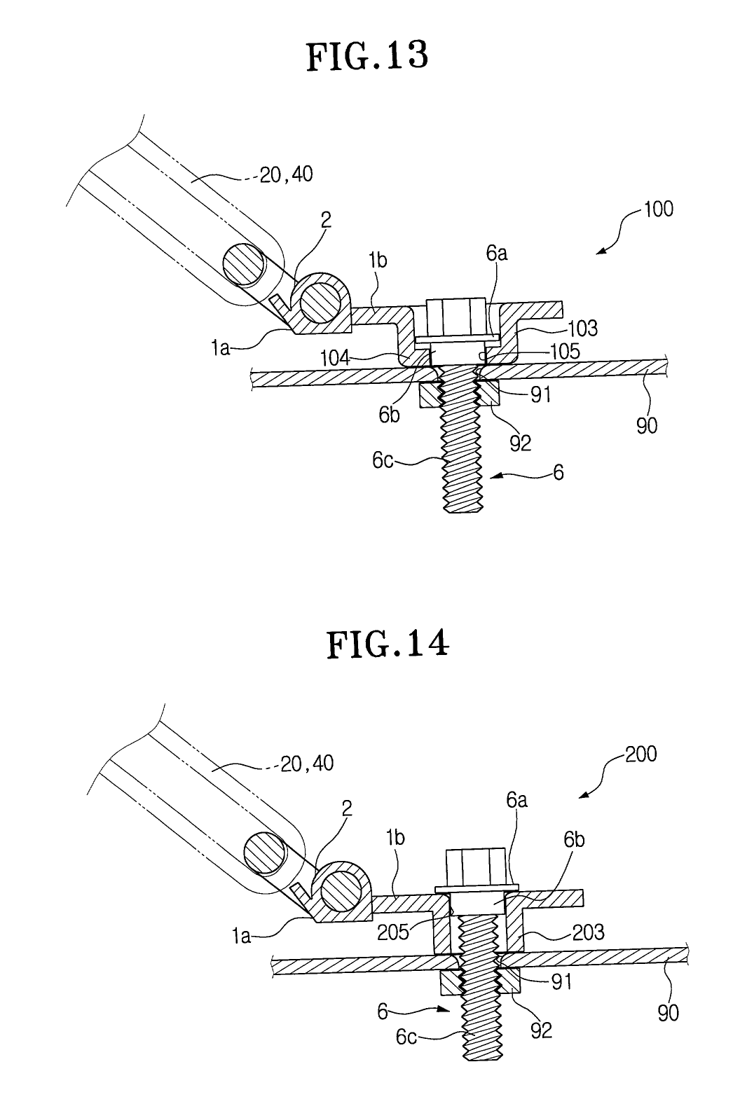

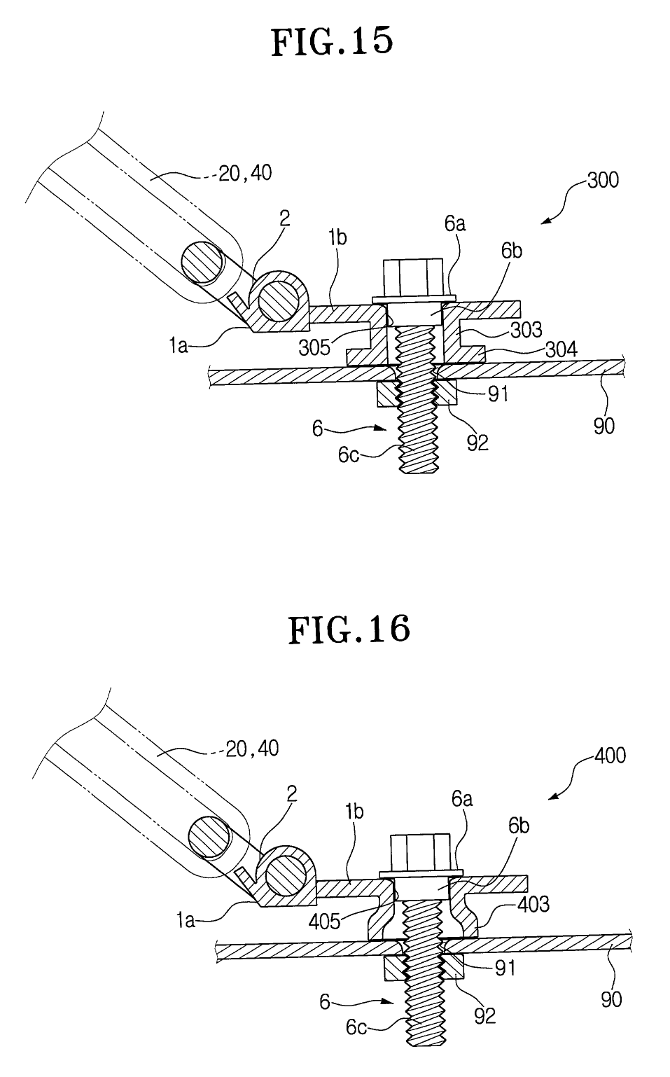

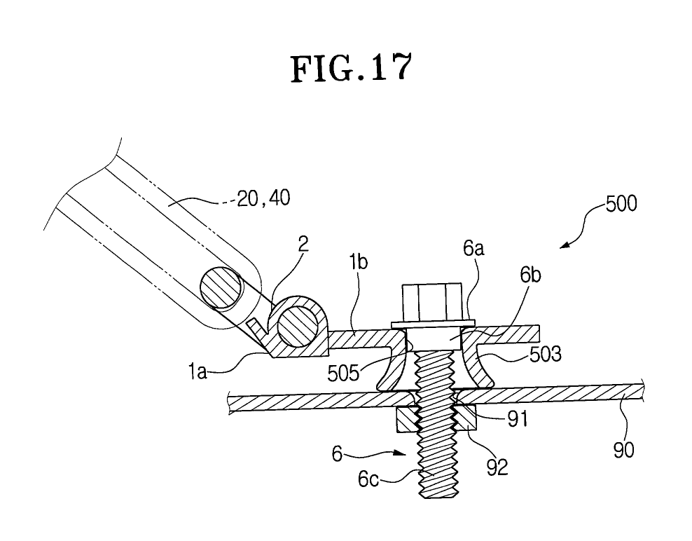

FIGS. 12 to 17 show the application of the improved anchor structure to the pillar anchor. FIGS. 12 thru 17 are identical with FIGS. 6 thru 11 respectively, which illustrate the anchor with the improved fixing structure and first to fifth embodiments of the fastener tube except the pillar anchor.

Hereinafter, a process for manufacturing the first embodiment of anchor with the improved fixing structure is described as follows:

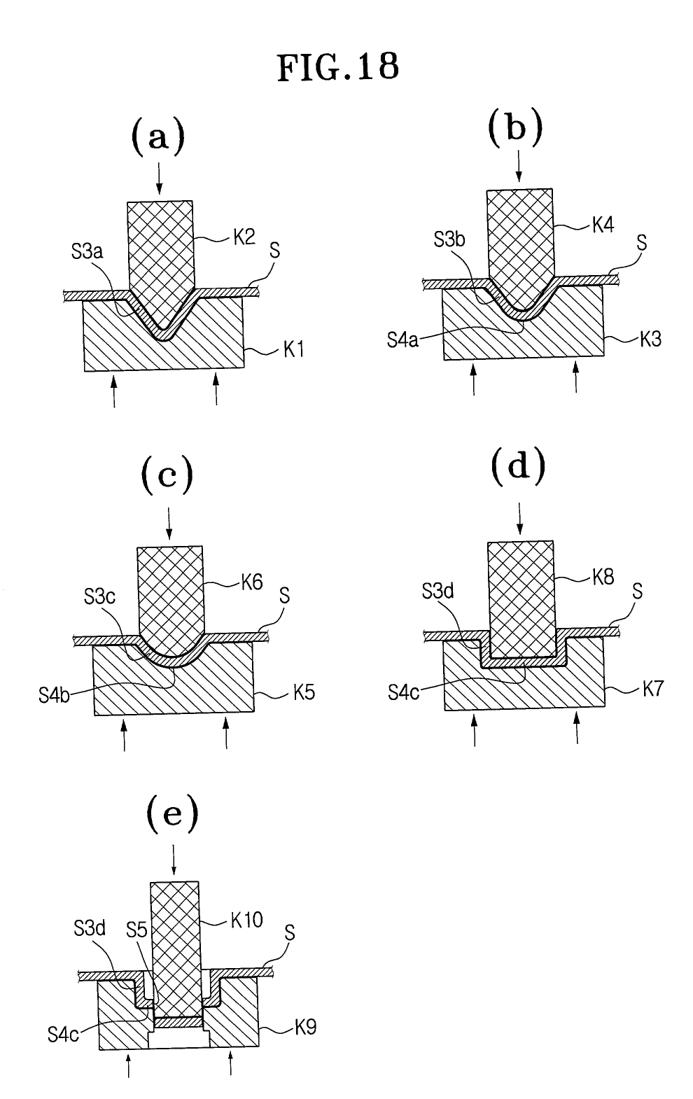

Referring to FIG. 18(a) to 18(e), a process for manufacturing an anchor with an improved fixing structure is illustrated that:

A first step, stamping process shown in FIG. 18(a) is to form an initial conical shape (S3a) having a predetermined depth. The steel plate (S) is disposed between a stamping set of punch (K2) and die (K1) having a conical wedge shape and a conical notch shape, respectively.

Second step, pressing process shown in FIG. 18(b) is to form a transition conical shape (S3b) by rounding a tip of initial conical shape (S3a). The pressing set of punch (K4) and die (K3) has relatively dull wedge shape and notch shape than that of previous step. Thus, a basin (S4a) of transition conical shape (S3b) is formed to be less depth than that of previous step by pressing the initial conical shape (S3a) to the radial direction.

Third step, expanding process shown in FIG. 18(c) is to form a transition semi-spherical shape (S3c) by expanding the transition conical shape (S3b) to the radial directions. A expanding set of press punch (K6) and die (K5) has a semispherical wedge shape and concave shape, respectively. The basin (S4b) of transition semi-spherical shape (S3c) has relatively less depth and wider surface than that of previous step.

Forth step, pressing process shown in FIG. 18(d) is to simultaneously form a cylindrical basin (S3d) having a final depth and a flat bottom surface (S4c). The depth of cylindrical basin (S3d) is less than that of previous step. A pressing set of punch (K8) and die (K7) has cylindrical edge shape and cylindrical basin shape, respectively.

Final step, punching process shown in FIG. 18(e) is to punch out a bolt hole (S5) for installing a bolt by a punching set of punch (K10) and die (K9).

If the steel plate (S) is excessively pressed or expanded during the manufacturing process, the thickness of steel plate (S) is decreased too thin beyond an allowable limit. As a result, the product is default and tensile strength would be too weakened to use for a seatbelt. In order to prevent the excessive expansion, four alternative processes for manufacturing a mini anchor with an improved fixing structure are introduced in the present specification. The basic process of alternative manufacturing processes is similar to that of process mentioned earlier in FIGS. 18(a) to 18(e).

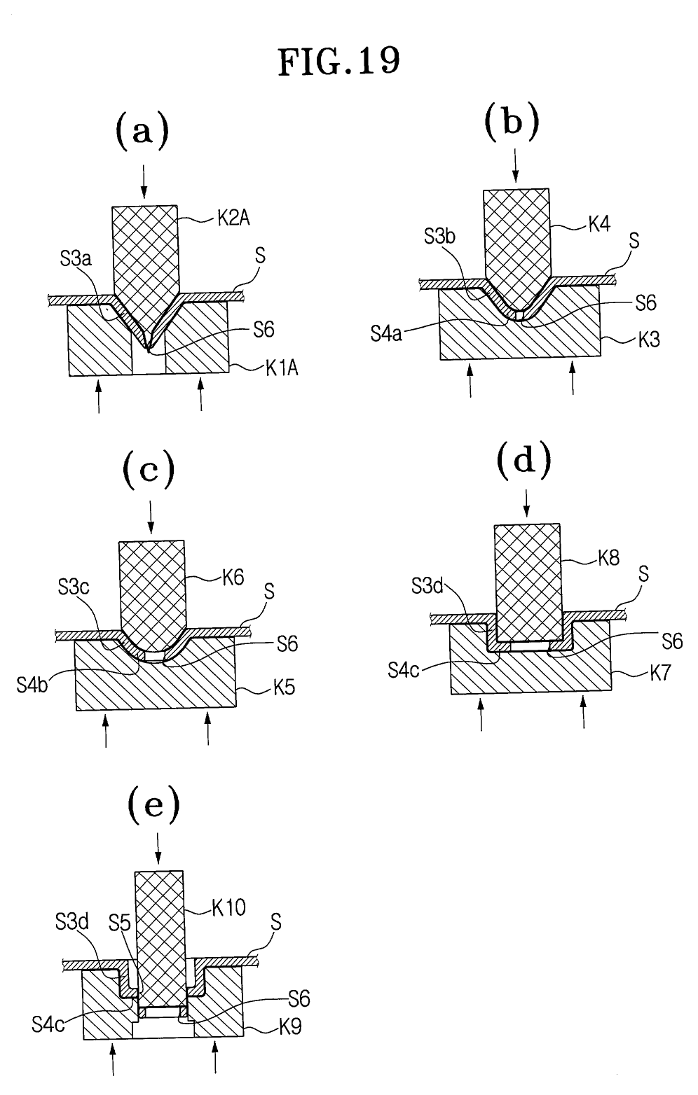

FIGS. 19(a) to 19(e) illustrate an alternative process of manufacturing an anchor for maintaining a consistent thickness of steel plate (S) during the manufacturing process.

FIG. 19(a) shows a first step, stamping process for forming an initial conical shape (S3a) with a predetermined depth. The steel plate (S) is disposed between a stamping set of punch (K2A) having a sharp point wedge (S6) at a tip of conical punch (K2A) and die (K2) having a conical notch with hollow portion at the center. The tip of initial conical shape (S3a) is simultaneously pierced while the initial conical shape (S3a) is being formed.

Due to the pierced portion (S6) at the tip of initial conical shape (S3a), it will prevent distortion of product from excessive expanding during the manufacturing process. Thus, the product is able to maintain a constant thickness throughout the manufacturing process. As a result, the tensile strength of product is kept within an acceptable limit. The rest process shown in FIGS. 19(b) to 19(e) is identical with the previous process shown in FIGS. 18(b) to 18(e), respectively. Therefore, the detailed descriptions of rest process are skipped here.

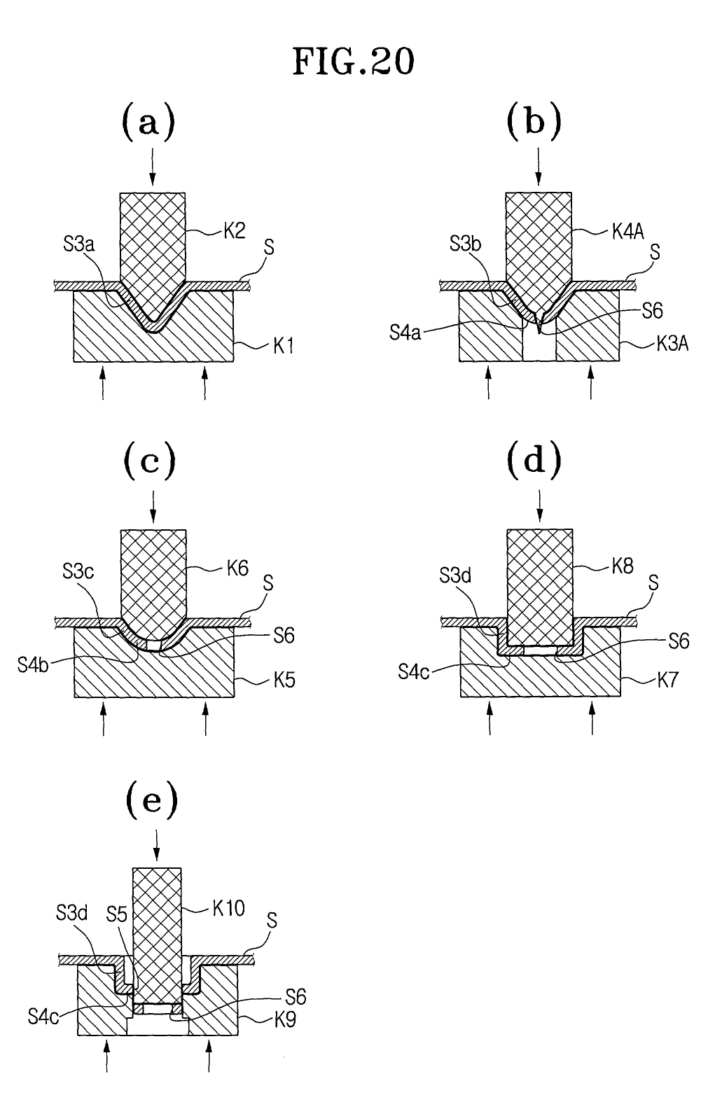

Another alternative process for manufacturing an anchor with an improved upper structure is illustrated through FIGS. 20(a) to 20(e).

Except the second step shown in FIG. 20(b), the first, third to final steps shown in FIGS. 20(a), 20(c) to 20(e) are identical with the first, third to final steps shown in FIGS. 18(a), 18(c) to 18(e), respectively.

As shown in FIG. 20(b), a second step of pressing process is to form a transition conical shape (S3b) by rounding the edge of initial conical shape (S3a). A pressing set has a punch (K4A) having relatively dull wedge shape with a sharp point (S6) and die (K3A) relatively dull notch shape with hollow portion at center. During the second step, the basin of transition conical shape (S3b) is simultaneously rounded up and pierced to have a hole. Due to a pierced portion (S6) formed at the tip of transition conical shape (S3b), it will prevent a distortion of product from excessive expanding during the manufacturing process. Therefore, the product is able to maintain a constant thickness throughout the manufacturing process. As a result, the tensile strength of product is maintained within an allowable limit. The rest process shown in FIGS. 20(c) through 20(e) is identical with the previous process shown in FIGS. 18(c) through 18(e), respectively. Therefore, the detailed descriptions of rest process are omitted hereinafter.

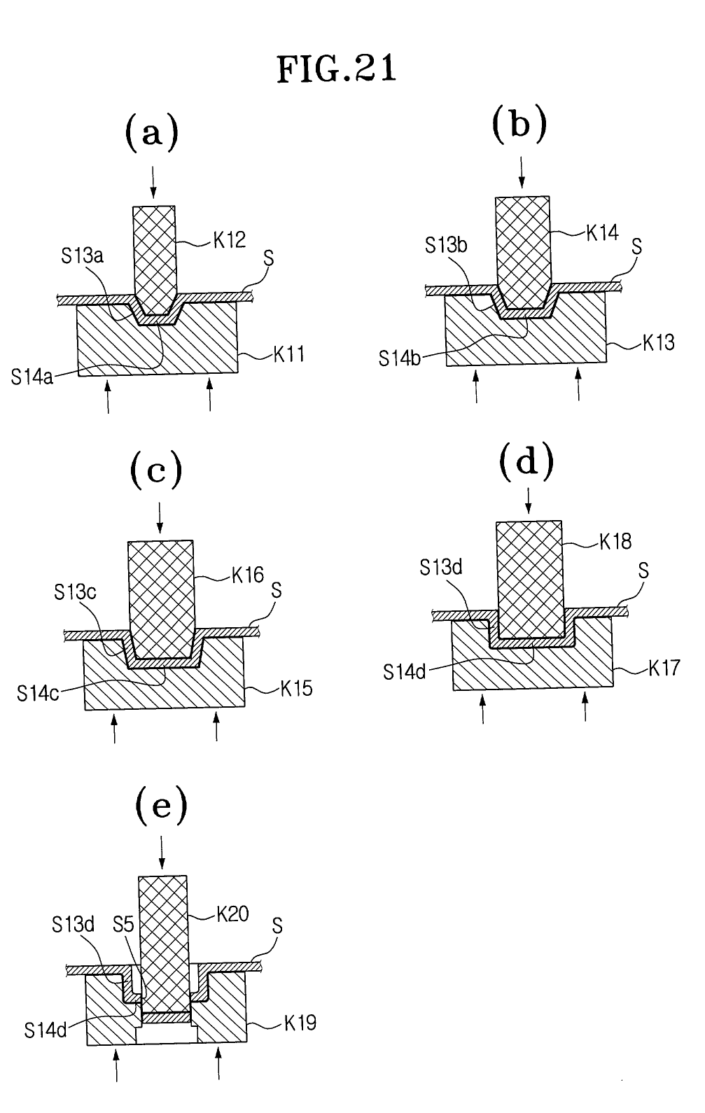

Still another alternative process of manufacturing an anchor with an improved upper structure is disclosed in FIGS. 21(a) through 21(e) as follows:

A first step, stamping process shown in FIG. 21(a) is to form an initial trapezoidal shape (S13a) having a predetermined depth. A steel plate (S) is disposed between a stamping set of punch (K12) having a trapezoidal wedge shape and die (K11) having a trapezoidal concave shape as a receptacle.

Second step, pressing process shown in FIG. 21(b) is to form a transition trapezoidal shape (S13b) by expanding the initial trapezoidal shape (S13a) to the radial direction. A pressing set of punch (K14) and die (K13) has relatively wider diameter and less tapered wedge and receptacle than that of previous step. A basin (S14b) of transition trapezoidal shape (S13b) is formed with less depth than that of previous step.

Third step, expanding process shown in FIG. 21(c) is to form a secondary transition trapezoidal shape (S13c) by further expanding the transition trapezoidal shape (S13b) to the radial directions. An expanding set of press punch (K16) and die (K15) has wider diameter and sharp tapered trapezoidal wedge and receptacle than that of previous step.

Forth step, pressing process shown in FIG. 21(d) is to simultaneously form a cylindrical basin (S13d) and flat bottom surface (S14d). A pressing set has a punch (K18) having cylindrical edge shape and die (K17) having cylindrical basin shape. The depth of cylindrical basin (S13d) is formed with less than that of previous step.

Final step, punching process shown in FIG. 21(e) is to punch out a bolt hole for installing a bolt by a punching set of die (K19) and punch (K20).

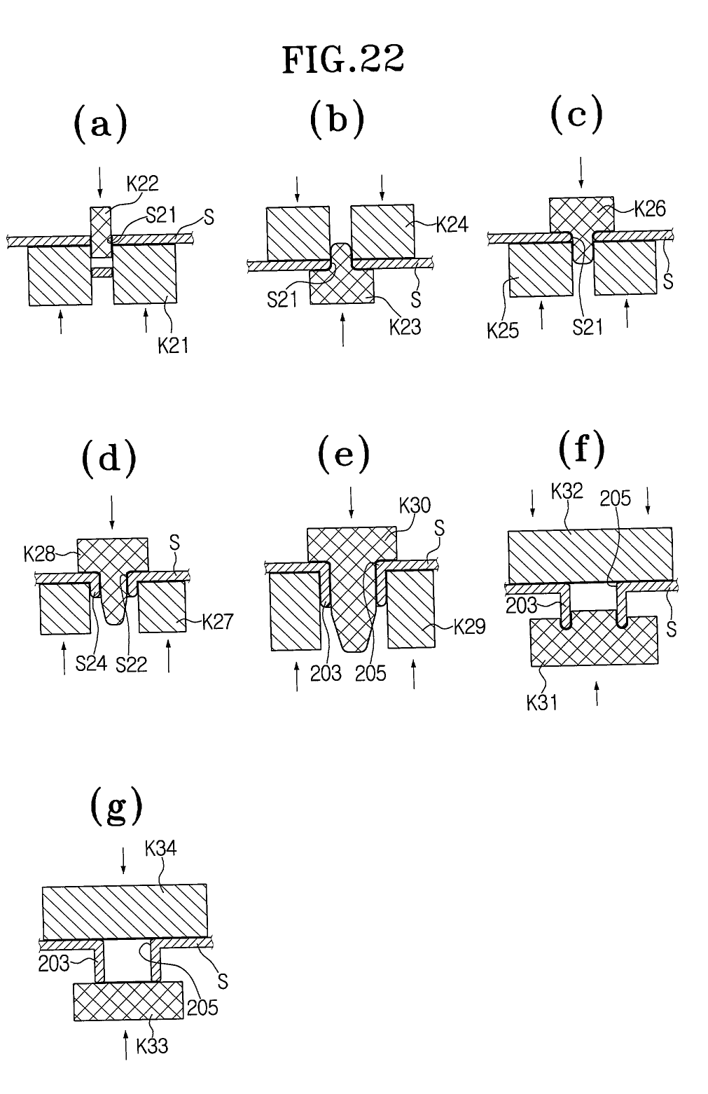

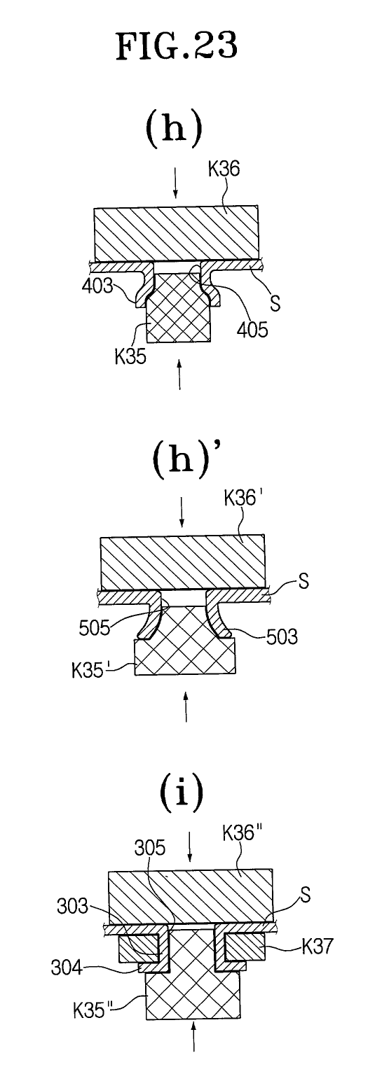

FIGS. 22(a) to (g) illustrate the common process for manufacturing the second to fifth embodiments of fastener tube of the present invention. Since each process of manufacturing the fastener tube is identical with each embodiment of the fastener tube except the expanding and trimming process, the descriptions of duplicated process are skipped hereinafter.

At first step shown in FIG. 22(a), a basic hole (S21) is punched out on a steel plate (s) by setting a steel plate between a punch (K22) and a die (K21) for forming an initial opening of fastener hole (205).

At second step shown in FIG. 22(b), a lower edge of inside basic hole (S21) is rounded up by a set of punch (K24) and die (K23).

At third step shown in FIG. 22(c), an upper edge of inside basic hole (S21) is rounded up by a set of punch (K26) and die (K25).

At forth step shown in FIG. 22(d), the basic hole (S21) is downwardly expanded to form a secondary basic hole (S22) by gradually increasing a punch size (K28). At the same time, the initial diameter of basic hole (S21) is enlarged to that of secondary basic hole (S22) by inserting and pressing down the punch (K28) against die (K27) to form a prototype fastener tube (S24).

At fifth step shown in FIG. 22(e), the secondary basic hole (S22) is further downwardly expanded to form a fastener tube (203) by gradually increasing a punch size (K30). At the same time, the diameter of secondary basic hole (S22) is further enlarged to that of fastener tube (203) by inserting and pressing down the punch (K30) against die (K29).

At sixth step shown in FIG. 22(f), an edge of fastener tube (203) is rounded up by a punch (K32) and die (K32).

At seventh step shown in FIG. 22(g), the edge of fastener tube (203) is trimmed to form a flat end. Through the above process, the second embodiment of the present invention (FIG. 8 and FIG. 14) is accomplished.

Further treatment of end portion of fastener tube enables to produce the third to fifth embodiment of fastener tubes.

At eighth step, the end part of fastener tube (403) is expanded and pressed up to form a bell shaped end having larger diameter than that of upper part of fastener tube (403) by an interior end expander (K35).

Alternatively, the end part of fastener tube (403) is expanded and pressed up to form a skirt shaped end of fastener tube (503) having diameter gradually increased from the upper part (505) to the end of fastener tube by a skirt shaped interior end expander (K35′).

Then, the end part of fastener tube (403) is further expanded and pressed up to form a flange (304) by a side semi-circular die (K37) and an stepped interior expander (K35″).

According to the present invention, the anchor with the improved fixing structure enable to provide not only a sufficient clearance between an upper part and a vehicle body panel without applying a bushing, but also a stable installation on the vehicle body panel. Because the fastener head is retained inside of bolt-mounting sink, it is possibly reduce the fastener length.

Consequently, the overall assembly cost for seatbelt could be remarkably reduced. The assembly worker is also free from worry of accidental omitting a bushing during the assembly.

While the present invention has been described in detail with its preferred embodiments, it will be understood that it further modifications are not limited. The present application is therefore intended to cover any variations, uses or adaptations of the invention following the general principles thereof, and includes such departures from the present disclosure as come within known or customary practice in the art to which this invention pertains within the limits of the appended claims.

What is claimed is:

1. An anchor with an improved fixing structure being made of a steel plate comprises a lower part (1a) with a slot (2) for suspending a seatbelt and an upper part (1b) for stably installing the anchor on a vehicle body panel by a fastener (6), the anchor with improved fixing structure is comprising:
said fastener (6) having a disk shaped stopper (6a), an inserting part (6b) and a thread part (6c),
a fastener tube (203) being integrally and vertically formed from said upper part (1b),
said fastener tube (203) having a predetermined height for providing a proper clearance between the anchor and vehicle body panel, and
an inner diameter of fastener tube (203) being formed slightly larger than an outer diameter of said thread part (6c) and smaller than an outer diameter of said disk shaped stopper (6a).

2. An anchor with an improved fixing structure being made of a steel plate comprises a lower part (1a) with a slot (2) for suspending a seatbelt and an upper part (1b) for stably installing the anchor on a vehicle body panel by a fastener (6), the anchor with improved fixing structure is comprising:
said fastener (6) having a disk shaped stopper (6a), an inserting part (6b) and a thread part (6c),
a fastener tube (203) being integrally and vertically formed from said upper part (1b) of the anchor, said fastener tube (203) having a consistent cross sectional area along the entire height,
said fastener tube (203) having a predetermined height for providing a proper clearance between the anchor and the vehicle body panel, and
an inner diameter of fastener tube (203) being formed slightly larger than an outer diameter of said thread part (6c) and smaller than an outer diameter of said disk shaped stopper (6a).

3. An anchor with an improved fixing structure of claim 2, wherein a flange (304) is integrally and radially formed at an end of said fastener tube (303) for stably seating on the vehicle body panel.

4. An anchor with an improved fixing structure of claim 2, wherein said end part of fastener tube (403) is expanded to form a bell shape having larger diameter than upper part of said fastener tube (405) for stably seating on the vehicle body panel.

5. An anchor with an improved fixing structure of claim 2, wherein said end part of fastener tube (503) is expanded to form a skirt shape being gradually increased diameter along the height of fastener tube (505) for stably seating on the vehicle body panel.

6. A process for manufacturing an anchor with an improved fixing structure having a lower part (1a) and an upper part (1b) for stably installing on a vehicle body panel, the process comprises steps of:
punching a basic hole (S21) on a steel plate (s) by setting said steel plate between a punch (K22) and die (K21) for forming an opening of fastener hole (205),
rounding a lower edge of inside basic hole (S21) by a set of punch (K24) and die (K23), and sequentially rounding an upper edge of inside basic hole (S21) by a set of punch (K26) and die (K25),
expanding the basic hole (S21) downwardly to form a secondary basic hole (S22) by gradually increasing a punch size (K28), simultaneously, enlarging the basic hole (S21) to form a secondary basic hole (S22) by inserting and pressing a punch (K28) against die (K27) for obtaining a prototype fastener tube (S24),
expanding the secondary basic hole (S22) further downwardly to form a fastener tube (203) by gradually increasing a punch size (K30), simultaneously, enlarging diameter of secondary basic hole (S22) further to that of fastener tube (203) by inserting and pressing the punch (K30) against die (K29) for obtaining a proper fastener tube (S24),
rounding an edge of fastener tube (203) by a punch (K31) and punch (K32), and
trimming the edge of fastener tube (203) to form a flat edge and consistent cross sectional area along the height of fastener tube (403).

7. A process for manufacturing an improved fixing structure of an anchor of claim 6, the process further comprises steps of:
expanding and trimming end part of fastener tube (403) to form a bell shape having larger diameter than that of upper part of fastener tube (403) for stably seating on the vehicle body panel.

8. A process for manufacturing an improved fixing structure of an anchor of claim 6, the process further comprises steps of:
eighth step, expanding and trimming end part of fastener tube (503) to form a skirt shaped end having gradually increased diameter from the upper part to end of fastener tube (505) for stably seating on the vehicle body panel.

9. A process for manufacturing an improved fixing structure of an anchor of claim 6, the process further comprises steps of:
eighth step, expanding and trimming the end part of fastener tube (303) to form a flange (304) for stably seating on the vehicle body panel.
